(19) United States
(12) Patent Application Publication
(10) Pub. No.: US 2020/0000121 A1
(43) Pub. Date: Jan. 2, 2020

(54) Dairy gluten free no sugar added coconut milk frozen desert compositions and products

(71) Applicants: Edward P. Zahora, Brattleboro, VT (US); Timothy W. Lawrence, Marlboro, VT (US); Daisy M. Aquirre Cleary, Wardsboro, VT (US); Abigail R. Gehring, Wardsboro, VT (US)

(72) Inventors: Edward P. Zahora, Brattleboro, VT (US); Timothy W. Lawrence, Marlboro, VT (US); Daisy M. Aquirre Cleary, Wardsboro, VT (US); Abigail R. Gehring, Wardsboro, VT (US)

(21) Appl. No.: 15/998,100

(22) Filed: Jun. 28, 2018

(51) Int. Cl. A23G 9/40; A23G 9/32; A23G 9/34; A23G 9/22; A23G 9/06

(52) U.S. Cl. CPC A23G 9/40; A23G 9/327; A23G 9/34; A23G 9/224; A23G 9/06; A23V 2300/31; A23V 2250/262; A23V 2250/6402; A23V 2250/6406; A23V 2300/20; A23V 2300/26; A23V 2002/00

(57) ABSTRACT

Described in preferred embodiments are dairy gluten free no sugar added coconut milk frozen desert compositions including a unique coconut milk, which have organoleptic qualities comparable to high fat frozen desserts such as ice cream. The compositions are composed of organic coconut milk comprising organic coconut solids and water, a sweetening agent and vegetable glycerin. Also described are dairy gluten free no sugar added flavors and inclusion compositions and methods for their production and incorporation into the dairy gluten free no sugar added coconut milk frozen desserts. Also provided are methods of making the frozen desert products.

### FIELD OF INVENTION

This invention relates to dairy gluten free no sugar added coconut milk frozen desert compositions including a unique coconut milk, which have organoleptic qualities comparable to high fat frozen desserts such as ice cream. The compositions are either aerated or quiescently frozen. Also described are dairy gluten free no sugar added flavors and inclusion compositions and methods for their production and incorporation into the dairy gluten free no sugar added coconut milk frozen desserts. The desert products are highly stable to heat shock with a high degree of creaminess providing a smooth, non greasy mouth feel. The compositions are composed of organic coconut milk comprising organic coconut solids and water, a sweetening agent and vegetable glycerin. Preferably, the compositions are composed of only natural ingredients without stabilizing gums. Also provided are methods of making the frozen desert products.

### BACKGROUND OF INVENTION

Frozen desserts such as, ice cream, ice milk, milk shakes, frozen yogurt, sorbet, sherbet, granita, gelato, etc., are popular consumer items. Some of these frozen desserts, such as ice cream, can be easily stored and shipped to grocery stores, co-ops, restaurants, etc. and still maintain a commercially acceptable body, flavor, and texture.

The present invention relates generally to blending Dairy Gluten Free No Sugar Added Coconut Milk Frozen Deserts and in certain embodiments of Dairy Gluten Free No Sugar Added Coconut Milk Frozen Desert compositions and Dairy Gluten Free No Sugar Added flavors and inclusions and methods for their production and incorporation into the Dairy Gluten Free No Sugar Added Coconut Milk Frozen Desserts. It is known that Dairy Gluten Free No Sugar Added Coconut Milk frozen desserts have offered lower or no exposure to dairy, gluten and sugar and are often the preferred frozen desert of choice because they offer distinct health advantages such as reduced risk to cancer, heart attack, diabetes, stroke, tooth decay, Parkinson's, multiple sclerosis and Alzheimer's over conventional ice creams with sugar and dairy present.

Despite the many advantages of current Dairy Gluten Free No Sugar Added Coconut Milk Frozen Desserts they still do not meet all expectations and often lack desirable properties and combinations of properties that are difficult to achieve with tradionally available technology. Traditional Dairy Gluten Free No Sugar Added Coconut Milk Frozen Desserts most often are comprised of lower fat content coconut milk (<22%). Although lower fat coconut milk imparts the desired health benefits in the Dairy Gluten Free No Sugar Added Coconut Milk Frozen Desserts, they are prone to crystallize and melt at lower temperatures. The lower fat coconut milk levels make the Dairy Gluten Free No Sugar Added Coconut Milk Frozen Desserts more susceptible to form crystals which give a rough texture to the Dairy Gluten Free No Sugar Added Coconut Milk Frozen Desserts, cause them to melt sooner than traditional dairy sugar ice creams and don't provide a smooth, non greasy mouth feel. This results in inadequate performance such as graininess and premature melting of the Dairy Gluten Free No Sugar Added Coconut Milk Frozen Desserts on a cone. Thus it can be difficult for a single Dairy Gluten Free No Sugar Added Coconut Milk Frozen Desert composition to provide the desired levels of scoopability, smoothness, flavor, sweetness, meltability and non greasy mouth feel. In the preferred embodiments, the present invention addresses the need for a Dairy Gluten Free No Sugar Added Coconut Milk Frozen Desert that along with the desirable health benefits offers properties of scoopability, smoothness, flavor, sweetness, meltability and non greasy mouth feel. Additionally, the current invention describes the processes for using these disclosed ingredients to achieve the desired Dairy Gluten Free No Sugar Added Coconut Milk Frozen Desserts.

### SUMMARY OF THE INVENTION

In certain aspects, the invention provides Dairy Gluten Free No Sugar Added Coconut Milk Frozen Desert compositions that include a unique blend of coconut milk and nonsugar sweeteners. The first ingredient of the blend is a unique coconut milk with coconut fat concentration at least 22% in solids. This Dairy Gluten Free No Sugar Added Coconut Milk Frozen Desert composition also includes at least one non sugar sweetener such as erythritol, etc. This Dairy Gluten Free No Sugar Added Coconut Milk Frozen Desert composition can include a second sweetener such as stevia. In preferred aspects the stevia sweetener does not have an after taste. The unique coconut milk has a solids range of 22-40%. The Dairy Gluten Free No Sugar Added Coconut Milk Frozen Desert can also contain a vegetable glycerin that adds sweetness and helps to reduce crystallinity, reduces the melting point and adds to the smoothness and scoopability. The Dairy Gluten Free No Sugar Added Coconut Milk Frozen Desert can also contain a thickener such as tapioca. The Dairy Gluten Free No Sugar Added Coconut Milk Frozen Desert can contain stabilizers. The Dairy Gluten Free No Sugar Added Coconut Milk Frozen Desert can also contain one or more non sugar added flavors and one or more non FD&C colorants to provide desirable flavors and appearance. The Dairy Gluten Free No Sugar Added Coconut Milk Frozen Desert can also contain one or more sugar free inclusions such as chocolate chips, brownies, cookie dough, chocolate chip cookie dough, coffee beans, vanilla beans and chocolate pieces.

In additional embodiments, the present invention provides frozen desserts and frozen desert processes involving the use of Dairy Gluten Free No Sugar Added Coconut Milk Frozen Desert compositions described herein. In certain forms an inventive Dairy Gluten Free No Sugar Added Coconut Milk Frozen Desert will have properties that provide a smooth grain free texture, non greasy mouth feel, easy scoopability, desirable sweetness and appearance, exceptional flavor and acceptable meltability. Meltability is defined as ability to stay firm on a cone for 5 minutes at room temperature, 70 degrees F. (21 degrees C.). In certain forms, the inventive process will include the formation of the Dairy Gluten Free No Sugar Added Coconut Milk Frozen Desert from an ice cream machine, a gelato machine or soft serve machine. The Dairy Gluten Free No Sugar Added Coconut Milk Frozen Desert can also be made by placing ingredients of the frozen desert product into a container having an open top; using a control valve to selectively dispense a cryogenic liquefied gas from a cryogenic tank into the container through a line having an opening mounted above the ingredients of the frozen desert product; and mechanically mixing the ingredients with the liquefied gas in the open top container to produce the frozen desert product; wherein a sufficient amount of the liquefied gas is introduced into the container to produce a visible amount of cryogenic vapor flowing from the open top of the container. The liquified gas can be liquefied nitrogen and/or liquefied carbon dioxide. Additional embodiments of the present invention as well as features and advantages thereof will be evident from the descriptions herein.

### DETAILED DESCRIPTION

This invention relates to dairy gluten free no sugar added coconut milk frozen desert compositions including a unique coconut milk, which have organoleptic qualities comparable to high fat frozen desserts such as ice cream. A dairy gluten free no sugar added coconut milk frozen desert is substantially free of graininess or grittiness and provides a smooth mouth feel even after being stored frozen for extended periods. The smooth, soft texture of the dairy gluten free no sugar added coconut milk frozen desert as well as the high flavor characteristics of the invention provides attributes that are desired by consumers. Other attributes of dairy gluten free no sugar added coconut milk frozen deserts that add to consumer acceptability are their freezer stability. The dairy gluten free no sugar added coconut milk frozen deserts can withstand extended frozen storage without extensive formation of large ice crystals that can be detrimental to the product.

Because the dairy gluten free no sugar added coconut milk frozen desert has a higher amount of coconut milk solids than traditional dairy gluten free no sugar added coconut milk frozen desert, its texture is smoother and softer. Although the invention is not limited to any single theory, it is believed that the higher amount of solids binds up sufficient water to reduce the number and/or size of ice crystals that can form and that the respective amounts of total solids and total coconut fat provides the desirable smooth, soft, silky texture and non greasy mouth feel.

The solids included in a dairy gluten free no sugar added coconut milk frozen desert include at least one coconut milk-solids source, at least one nonsugar sweetener source, and a vegetable glycerin source. A high coconut milk solids source is provided to contribute to the stability of the dairy gluten free no sugar added coconut milk frozen desert. A high coconut milk solids source of high molecular weight compounds provide body and texture to a dairy gluten free no sugar added coconut milk frozen desert of the invention, decrease sensitivity to temperature fluctuations, and increase stability. A dairy gluten free no sugar added coconut milk frozen desert should include a coconut milk solids source in an amount effective to achieve a smooth, soft texture with non greasy mouth feel. Yet a dairy gluten free no sugar added coconut milk frozen desert of the invention should not include a coconut milk solids source in an amount that would cause undesirable hardness or texture in the final frozen product.

A nonsugar sweetener source in a dairy gluten free no sugar added coconut milk frozen desert is provided to add sweetness and to contribute to the stability of the dairy gluten free no sugar added coconut milk frozen desert by providing solids. A nonsugar source includes any source suitable for achieving the sweetness desired in a final frozen product and for contributing to the desired amount of solids for binding water.

A vegetable glycerin is provided in a dairy gluten free no sugar added coconut milk frozen desert of the invention to provide sweetness and desirable mouth feel.

A dairy gluten free no sugar added coconut milk frozen desert of the invention also includes a balance of water.

A dairy gluten free no sugar added coconut milk frozen desert of the invention may optionally include a gum/stabilizer to provide for improved transport stability. That is, a dairy gluten free no sugar added coconut milk frozen desert of the invention can be transported by the consumer between, for example, a grocery store and home and not appear too watery or liquid upon opening the container at home.

A dairy gluten free no sugar added coconut milk frozen desert of the invention can include flavorants, such as, for example vanilla, chocolate, coffee, fruit, nut liqueur, vegetable, tea, candy, etc. These flavorants can be provided in the form of, for example, powder, puree, paste, syrup, concentrate, alcohol, liquid, solid, etc. Depending on the type and/or form of flavorant added, the amount of solids may need to be adjusted according to the ranges provided in the specifications.

A dairy gluten free no sugar added coconut milk frozen desert of the invention can be stored for up to one year or more and still retain a texture characteristic of freshly made dairy gluten free no sugar added coconut milk frozen desert.

To prepare a dairy gluten free no sugar added coconut milk frozen desert of the invention, a base mixture including, for example, at least one coconut milk solids source, at least one non sugar sweetener source, at least one vegetable glycerin source and water are blended to a homogeneous mixture. The liquid mixture was then transformed into a semi frozen solid by cooling the liquid mixture to between about 20 degrees F. (−6.7 degrees C.) and about 25 degrees F. (−3.9 degrees C.). Flavorants can be added prior to homogenization. Inclusions can be added after a semi frozen solid is obtained. This mixture is then quickly hardened by passing through a hardening tunnel and cooling the mixture to between −10 degrees F. (−23.3 degrees C.) and −35 degrees F. (−37.2 degrees C.). Preferably the mixture is hardened as soon as possible to facilitate the stability of the dairy gluten free no sugar added coconut milk frozen desert. The stability of the dairy gluten free no sugar added coconut milk frozen desert is improved if smaller ice crystals form. Preferably the temperature of the semi frozen product does not increase more than about 5 degrees F. (5 degrees C.) above its temperature upon exiting the freezer when it enters the hardening tunnel.

A dairy gluten free no sugar added coconut milk frozen desert of the invention base mixture once blended should be keep at least at 75 degrees F. (23.9 degrees C.) before cooling and freezing to prevent the coconut milk solids from agglomerating and coming out of the blended mixture.

This invention will be further characterized by the following examples. These examples are not meant to limit the scope of the invention, which has been fully set forth in the foregoing description. Variations within the scope of the invention will be apparent to those skilled in the art.

### EXAMPLES

The following examples depict a nonlimiting illustration of the various attributes of the invention.

### Example 1 Ecuadorian Chocolate Dairy Gluten Free No Sugar Added Coconut Milk Frozen Desert

To prepare a dairy gluten free no sugar added coconut milk frozen desert of the invention, a base mixture including one coconut solids source, water, nonsugar sweeteners erythritol and stevia, vegetable glycerin and Ecuadorian chocolate are blended to a homogeneous mixture.

The liquid mixture was then transformed into a semi frozen solid by cooling the liquid mixture to between about 20 degrees F. (−6.7 degrees C.) and about 25 degrees F. (−3.9 degrees C.). This mixture is then quickly hardened by passing through a hardening tunnel and cooling the mixture to between −10 degrees F. (−23.3 degrees C.) and −35 degrees F. (−37.2 degrees C.). Preferably the mixture is hardened as soon as possible to facilitate the stability of the dairy gluten free no sugar added coconut milk frozen desert. The stability of the dairy gluten free no sugar added coconut milk frozen desert is improved if smaller ice crystals form. Preferably the temperature of the semi frozen product does not increase more than about 5 degrees F. (5 degrees C.) above its temperature upon exiting the freezer when it enters the hardening tunnel.

### Amount and Ingredient

27 Fluid oz Organic Coconut Milk (minimum of 22% solids)

### ½ Cup Organic Erythritol

1 Tablespoon Organic Sweetleaf Stevia from Wisdom Natural Brands
½ Cup Organic Vegetable glycerin

### ¼ Cup Organic Ecuadorian Cacao Powder

To obtain and maintain the silky, smooth, soft texture non greasy mouth feel of a dairy gluten free no sugar added coconut milk frozen desert of the invention, the structure of the dairy gluten free no sugar added coconut milk frozen desert must be characterized by desirable stability. A suitable way to determine the stability of a dairy gluten free no sugar added coconut milk frozen desert includes evaluating the ice crystals found in the frozen desert. All frozen desserts have at least some ice crystals. It is undesirable to completely eliminate all ice crystals because the ice crystals deliver the cold sensation to a consumer's mouth. If the ice crystals are too large, for example, greater than 80 microns, they have an undesirable textural feel in the mouth. Preferably the ice crystals are sized between 20 and 50 microns when stored at 10 degrees F. (−12 degrees C.) for two weeks or longer.

To determine ice-crystal size, a sample of a dairy gluten free no sugar added coconut milk frozen desert is analyzed under a microscope. This procedure may only be used to determine the size of ice crystals that are no greater than about 100 microns.

A dairy gluten free no sugar added coconut milk frozen desert sample is taken from one inch down in the center of a pint of dairy gluten free no sugar added coconut milk frozen desert of the invention. A thin layer of the dairy gluten free no sugar added coconut milk frozen desert sample (approximately 1 mm in diameter) is dispersed in mineral oil, which is cooled to at least −20 degree C., on a glass slide. A cover slip that is cooled to at least −20 degree C. is applied over the sample. An eraser of a pencil that is cooled to at least −20 degree C. is used to press down the cover slip and spread the ice cream very thinly throughout the mineral oil. When pressing down the cover slip, care is taken not to apply so much pressure that the ice crystals in the sample cracked.

The glass slide is inserted into a thermal microscope stage and tank unit (Physitemp Model TS-4 adapted for ice crystals, Physitemp Instruments Inc., Clifton, N.J.), and a stream of nitrogen is applied over the stage. The thermal microscope stage is equipped with an immersion cooler (Lauda Model IC-6, Lauda-Konigshofen, Germany), and the sample is maintained at no more than −20 degree C.

The sample is viewed through a light microscope configured with a 10 times objective. If the ice crystals appear to be mostly overlapped, then the slide is quickly removed and the cover slip is moved around to further disperse the sample in the mineral oil. When the ice crystals in the sample are not substantially overlapping, a photomicrograph is taken by a Zeiss Microscope Camera, Model MC63A (Carl Zeiss, Inc., New York). The photomicrograph image is processed in a. Cambridge Instruments Quantimet 570 image processing and analysis system (Cambridge Instruments, Inc., Illinois), and the image is quantified using the Quantimet 570 program, which calculates the mean-equivalent diameter data of the ice crystals. Preferably photomicrograph data are obtained when at least 50 particles are pictured. Only crystals that are not overlapping or are not touching an edge of the picture are counted in the 50-particle number. Duplicate samples are prepared and analyzed.

Calibration of the digitizing equipment is confirmed by digitizing a photograph using a micrometer or standard particles.

### Example 2 Mint Chocolate Chip Dairy Gluten Free No Sugar Added Coconut Milk Frozen Desert

### Amount and Ingredient

27 Fluid oz Organic Coconut Milk (minimum of 22% solids)

### ½ Cup Organic Erythritol

1 Tablespoon Organic Sweetleaf Stevia from Wisdom Natural Brands
¼ Cup Organic Vegetable glycerin

### 3 Tablespoons Organic Tapioca

2 Teaspoons Organic Mint Extract from Green Mountain Flavors
½ Cup Lilly's Chocolate Chips (or as needed for flavor) Sugar and Dairy Free

### Example 3 Cherry Chocolate Chip Dairy Gluten Free No Sugar Added Coconut Milk Frozen Desert

### Amount and Ingredient

27 Fluid oz Organic Coconut Milk (minimum of 22% solids)

### ½ Cup Organic Erythritol

1 Tablespoon+1 Teaspoon Organic Sweetleaf Stevia from Wisdom Natural Brands

### ½ Teaspoon Organic Citric Acid

¼ Cup Organic Vegetable glycerin

### ¼ Cup Organic Tapioca

1 Teaspoon Natural Cherry Flavor #53115 from Green Mountain Flavors
2 Tablespoons Red Beet Concentrate from Green Mountain Flavors
½ Cup Lilly's Chocolate Chips (or as needed for flavor) Sugar and Dairy Free

### Example 4 Maple Walnut Dairy Gluten Free No Sugar Added Coconut Milk Frozen Desert

### Amount and Ingredient

27 Fluid oz Organic Coconut Milk (minimum of 22% solids)

### ½ Cup Organic Erythritol

1 Tablespoon Organic Sweetleaf Stevia from Wisdom Natural Brands
¼ Cup Organic Vegetable glycerin

### ¼ Cup Organic Tapioca

2 Tablespoons Natural Maple Flavor #63139 from Green Mountain Flavors
2 Tablespoons Carmel Color Class 1 from Green Mountain Flavors
1 Cup Chopped Organic Walnuts (or as needed for flavor)

### Example 5 Chocolate Chip Cookie Dough

### Amount and Ingredient

### 1 15 oz (425 g) can Organic Chickpeas

### 1/4 Cup Organic Coconut Butter

### ½ Cup Organic Erythritol

1 Tablespoon Organic Sweetleaf Stevia from Wisdom Natural Brands
¼ Cup+1 tablespoon Organic Flaxmeal
⅛ teaspoon baking soda

### ½ Cup Lilly“s Chocolate Chips Sugar and Dairy Free

Drain Chickpeas, rinse extremely well, and pat dry. Process all ingredients except chocolate chips in a strong food processor until completely smooth. Stir in Chips. Roll out dough to ¼ inch thickness and place on wax paper. Freeze till firm. Cut ¼×¼×¼ inch (6.4×6.4×6.4 mm) squares then roll in tapioca to keep from sticking and freeze hard. Store in a freezer until ready to blend into the semi frozen dairy gluten free no sugar added coconut milk desert.

### Example 6 Black Bean Brownies

### Amount and Ingredient

1 15 oz (425 g) can Organic Black Beans, well rinsed and drained
2 Large flax eggs (2 heaping Tablespoons (16 g) Organic flaxseed meal+6 Tablespoons water)
3 Tablespoons coconut oil, melted

### ¾ Cup Organic Ecuadorian Cacao Powder

¼ teaspoon sea salt

### ½ Cup Organic Erythritol

1 Tablespoon Organic Sweetleaf Stevia from Wisdom Natural Brands
1½ Teaspoons baking powder

Preheat oven to 350 degrees F. (176 degrees C.). Lightly grease a flat pan. Make sure the black beans are rinsed and thoroughly drained. Prepare flax egg by combining flax and water in the bowl of a food processor. Pulse a couple times and then let rest for a few minutes. Add remaining ingredients and puree about 3 minutes scraping down sides as needed. Needs to be smooth. If the batter appears too thick, add a tablespoon or two of water and pulse again. It should be slightly less thick than chocolate frosting but not runny. Evenly distribute the batter into the greased pan and smooth the tops with a spoon. Bake for 30-40 minutes or until the tops are dry and the edges start to pull away from the sides. Use a fork to make sure the insides are not fuggy but firm and dry. If moist and fuggy continue to bake until firm and dry. Remove from the oven and let cool for 30 minutes before removing from the pan. Place on wax paper and use a fork to break up into small pieces ¼ inch (6.4 mm) in length or less. Roll with tapioca to keep from sticking and freeze hard. Store in a freezer until ready to blend into the semi frozen dairy gluten free no sugar added coconut milk desert.

### Example 7 Ecuadorian Chocolate Chocolate Chip Dairy Gluten Free No Sugar Added Coconut Milk Frozen Desert

To the Ecuadorian Chocolate dairy gluten free no sugar added coconut milk frozen desert in Example 1 blend in ½ Cup Lilly's Chocolate Chips (or as needed for flavor).

### Example 8 Ecuadorian Chocolate Chocolate Chip Cookie Dough Dairy Gluten Free No Sugar Added Coconut Milk Frozen Desert

To the Ecuadorian Chocolate dairy gluten free no sugar added coconut milk frozen desert in Example 1 blend in ½ Cup Chocolate Chip Cookie Dough made as described in Example 5.

### Example 9 Ecuadorian Chocolate Chocolate Chip Brownies Dairy Gluten Free No Sugar Added Coconut Milk Frozen Desert

To the Ecuadorian Chocolate dairy gluten free no sugar added coconut milk frozen desert in Table 1 blend in ¼ Cup Lilly's Chocolate Chips and ¼ Cup Black Bean Brownies made as described in Example 6.

### Example 10 Ecuadorian Chocolate Chocolate Chip Cookie Dough Brownies Dairy Gluten Free No Sugar Added Coconut Milk Frozen Desert—Named Fully Awake

To the Ecuadorian Chocolate dairy gluten free no sugar added coconut milk frozen desert in Example 1 blend in ¼ Cup Lilly's Chocolate Chips, ¼ Cup Black Bean Brownies made as described in Example 6 and ¼ Cup Chocolate Chip Cookie Dough made as described in Example 5.

The above specifications, examples, and data provide a complete description of the manufacture and use of the composition of the invention. Since many embodiments of the invention can be made without departing from the spirit and scope of the invention, the invention resides in the claims hereinafter appended.

The claimed invention is:

1. A dairy gluten free no sugar added coconut milk composition suitable for preparing a frozen desert product, comprised of organic coconut milk comprising organic coconut solids and water, a sweetening agent and organic vegetable glycerin, the composition being free of added stabilizing gums, wherein the composition is capable of substantially retaining creaminess with substantially reduced iciness under conditions of freezing when the composition is aerated and frozen or is quiescently frozen providing a smooth, non greasy mouth feel.

2. The composition of claim 1, wherein the composition can be stored for up to 1 year at temperatures about −20 degrees F. (−28.9 degrees C.) and have ice crystals sized between about 30 and 80 microns.

3. A composition according to claim 1 comprising a sweetening agent in an amount of about 0.001-20 wt %, coconut solids of about 22-40 wt % or a combination thereof, the weight percentages being based on the total weight of the composition.

4. A composition according to claim 1 comprising a sweetening agent in an amount of about 0.001-20 wt %, water in amount effective to achieve a total solids content of about 30-50%, wherein the coconut solids are present in an amount of at least of about 22-40 wt %, and the vegetable glycerin is present in an amount of about 5-20%, the weight percentages being based on the total weight of the composition.

5. A composition according to claim 1 suitable for preparing a frozen desert product, comprising a sweetening agent of erytheritol in an amount of about 0.001-20 wt %, or stevia in an amount of about 0.001-5 wt %, or a combination thereof, water in amount effective to achieve a total solids content of about 30-50%, wherein the coconut solids are present in an amount of at least of about 22-40 wt %, and the vegetable glycerin is present in an amount of about 5-20%, the weight percentages being based on the total weight of the composition, and being free of added stabilizing gums, wherein the composition is capable of substantially retaining creaminess with substantially reduced iciness under conditions of freezing when the composition is aerated and frozen or is quiescently frozen providing a smooth, non greasy mouth feel.

6. A frozen desert product comprising: a frozen, sweetened, aqueous composition comprising a sweetening agent in an amount of about 0.001-20 wt %, water in amount effective to achieve a total solids content of about 30-50%, wherein the coconut solids are present in an amount of at least of about 22-40 wt %, and the vegetable glycerin is present in an amount of about 5-20 wt %, the weight percentages being based on the total weight of the composition, and being free of added stabilizing gums, wherein the composition is capable of substantially retaining creaminess with substantially reduced iciness under conditions of freezing providing a smooth, non greasy mouth feel.

7. A desert product according to claim 6, wherein the desert product can be stored for up to 1 year at temperatures about −20 degrees F. (−28.9 degrees C.) and have ice crystals sized between about 30 and 80 microns.

8. A desert product according to claim 6, wherein the composition has an overrun of from about 10% to 120%.

9. A desert product according to claim 6, further comprising a sweetening agent of erytheritol in an amount of about 0.001-20 wt %, or stevia in an amount of about 0.001-5 wt %, or a combination thereof, the weight percentages being based on the total weight of the desert product.

10. A desert product according to claim 6, further comprising a flavorant

11. A desert product according to claim 10, wherein the flavorant provides chocolate flavor, candy flavor, coffee flavor, nut flavor, fruit flavor, liqueur flavor, or a combination thereof.

12. A desert product according to claim 6, further comprising an inclusion or any combination of inclusions.

13. A desert product according to claim 12, wherein the inclusion is a chocolate particle, a chocolate chip cookie dough, a nut, a bean, a fruit, a cookie, a candy, a brownie or any combination of inclusions.

14. A desert product according to claim 13, wherein the inclusion is a chocolate particle which is sugar and dairy free, a chocolate chip cookie dough which is sugar and dairy free, a cookie which is sugar and dairy free, a candy which is sugar and dairy free, a brownie which is sugar and dairy free, or any combination of inclusions.

15. A desert product according to claim 14, wherein the inclusion is a chocolate particle which is sweetened with erythritol and/or stevia, a chocolate chip cookie dough which is sweetened with erythritol and/or stevia, a cookie which is sweetened with erythritol and/or stevia, a candy which is sweetened with erythritol and/or stevia, a brownie which is sweetened with erythritol and/or stevia or any combination of inclusions.

16. A desert product according to claim 15, wherein the desert product can be stored for up to 1 year at temperatures about −20 degrees F. (−28.9 degrees C.) and have ice crystals sized between about 30 and 80 microns.

17. A desert product according to claim 6, further comprising a gum stabilizer.

18. A method of preparing a desert product, comprising:
(a) blending together a mixture of a desert product according to claim 6 further comprising a sweetening agent of erythritol in an amount of about 0.001-20 wt %, or stevia in an amount of about 0.001-5 wt %, or a combination thereof, the weight percentages being based on the total weight of the desert product;
(b) homogenizing the mixture;
(c) freezing the mixture to produce the desert product, said desert product being capable of retaining creaminess with substantially reduced iciness under conditions of freezing providing a smooth, non greasy mouth feel.

19. A method according to claim 18, wherein the freezing step is conducted in two stages, the first including agitation to provide an overrun of about 15-120% and the second being conversion of the product to a hard consistency.

20. A method according to claim 18, wherein the frozen desert product will stay firm on a cone for 5 minutes at room temperature, 70 degrees F. (21 degrees C.).

21. A method of making a frozen desert product according to claim 5 comprising: placing ingredients of the frozen desert product into a container having an open top; using a control valve to selectively dispense a cryogenic liquefied gas from a cryogenic tank into the container through a line having an opening mounted above the ingredients of the frozen desert product; and mechanically mixing the ingredients with the liquefied gas in the open top container to produce the frozen desert product; wherein a sufficient amount of the liquefied gas is introduced into the container to produce a visible amount of cryogenic vapor flowing from the open top of the container.

22. The method of claim 21, wherein the liquefied gas is liquefied nitrogen and/or liquefied carbon dioxide.
